(19) United States
(12) Patent Application Publication
(10) Pub. No.: US 2015/0001781 A1
(43) Pub. Date: Jan. 1, 2015

(54) PRINTING MEDIUM FINISHING UNIT AND IMAGE FORMING APPARATUS HAVING THE SAME

(71) Applicant: SAMSUNG ELECTRONICS CO., LTD., Suwon-si (KR)

(72) Inventor: Jeong Yeon PARK, Hwaseong-si (KR)

(73) Assignee: SAMSUNG ELECTRONICS CO., LTD., Suwon-si (KR)

(21) Appl. No.: 14/315,780

(22) Filed: Jun. 26, 2014

(30) Foreign Application Priority Data
Jun. 27, 2013 (KR) 10-2013-0074355

(51) Int. Cl. B41F 13/56; B65H 45/04

(52) U.S. Cl. CPC B41F 13/56; B65H 45/04
USPC 270/4; 493/454

(57) ABSTRACT

A printing medium finishing unit including a plurality of pressing modules each configured to deform rear ends of folded printing media into a different shape by pressing the rear ends and an image forming apparatus having the same.

### CROSS-REFERENCE TO RELATED APPLICATIONS

This application claims the benefit of Korean Patent Application No. 10-2013-0074355, filed on Jun. 27, 2013 in the Korean Intellectual Property Office, the disclosure of which is incorporated herein by reference.

### BACKGROUND

1. Field

Embodiments of the present disclosure relate to a printing medium finishing unit that receives printing media, which are completed with image formation by an image forming unit, and performs folding on the received printing media, and an image forming apparatus having the same.

2. Description of the Related Art

In general, an image forming apparatus represents an apparatus designed to form an image on a printing medium, and may include a printer, a copy machine and a multifunctional device.

The examples of image forming apparatuses include an image forming apparatus provided with an image forming unit that is configured to form an image and a printing medium finishing unit that receives a printing medium completed with image formation and performs a finishing process on the printing medium.

The printing medium finishing unit is configured to perform a stapling task through a stapler or a folding task in which middle portions of printing media are folded into a shape of a book.

In addition, the printing medium finishing unit includes a square back processing unit that allows rear ends of the folded printing media to have squared shapes, so that the folded printing medium have a shape similar to a real book.

### SUMMARY

Therefore, it is an aspect of the present disclosure to provide a printing medium finishing unit having a rear edge of the folded printing media improved while lowering a chance of damage to the printing media, and an image forming apparatus having the same.

It is another aspect of the present disclosure to provide a printing medium finishing unit having rear ends selectively folded into various shapes, and an image forming apparatus having the same.

Additional aspects of the disclosure will be set forth in part in the description which follows and, in part, will be obvious from the description, or may be learned by practice of the disclosure.

In accordance with embodiments of the present disclosure, a printing medium finishing unit and an image forming apparatus having the same includes a back processing unit. The back processing unit may be provided with a plurality of pressing modules each configured to deform rear ends of folded printing media into a different shape by pressing the rear ends of the folded printing media.

The plurality of pressing modules may include a first pressing module configured to deform the rear ends of the folded printing media into squared shapes by pressing the rear ends of the folded printing media, and a second pressing module configured to deform edges of the folded printing media P that are formed by the first pressing module into flat surfaces by pressing the edges of the folded printing media.

The first pressing module may be installed so as to be movable in a width direction of the folded printing medium. The first pressing module may include a first pressing roller that is provided in a cylindrical shape to press the rear ends of the folded printing media.

The second pressing module may be installed so as to be movable in a width direction of the folded printing medium. The second pressing module may include a second pressing roller that is provided at an outer circumferential surface thereof with a V-shaped groove formed along a circumferential direction thereof.

The back processing unit may include a driving motor generating a rotary force, a driving pulley rotated by the driving motor, a driven pulley disposed while being spaced apart from the driving pulley and a transfer belt wound around the driving pulley and the driven pulley. The first pressing module and the second pressing module may be installed on the transfer belt.

The back processing unit may include one pair of support plates that are spaced apart from each other and support both sides of the folded printing media.

The printing medium finishing unit may further include one pair of folding rollers disposed apart from each other, and a folding knife movably installed and having a front end entering a portion between the folding rollers.

The one pair of folding rollers may include a fixed roller rotatably installed at a fixed position, and a moving roller installed so as to be movable toward the fixed roller.

In accordance with another aspect of the present disclosure, an image forming apparatus includes an image forming unit and a printing medium finishing unit. The image forming unit may form an image on a printing medium. The printing medium finishing unit may be connected to one side of the image forming unit to fold printing media transmitted from the image forming unit. The printing medium finishing unit may include a plurality of pressing modules each configured to deform rear ends of folded printing media into a different shape by pressing the rear ends of the folded printing media.

As described above, edges of the folded printing media are selectively deformed in various shapes through a plurality of pressing modules.

In addition, edges of the folded printing medium are deformed into flat shapes through a first pressing roller and a second pressing roller, so that the edges of the folded printing media have improved strength and are unlikely to be damaged.

In addition, wrinkles that may be generated during a back processing by the first pressing roller are stretched by the second pressing roller, so that the external appearance of the folded printing media is improved.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a schematic view illustrating an image forming apparatus, a printing medium finishing unit and a back processing unit in accordance with an embodiment of the present disclosure.

FIG. 2 is a side view schematically illustrating an operation principle of the printing medium finishing unit in accordance with an embodiment of the present disclosure.

FIG. 3 is a plan view schematically illustrating the back processing unit in accordance with an embodiment of the present disclosure.

FIGS. 4 and 6 are plan views illustrating an operation of the back processing unit in accordance with an embodiment of the present disclosure.

FIGS. 5 and 7 are side views illustrating an operation of the back processing unit in accordance with an embodiment of the present disclosure.

FIG. 8 is an enlarged view illustrating rear ends of the folded printing media that are deformed by the back processing unit in accordance with an embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

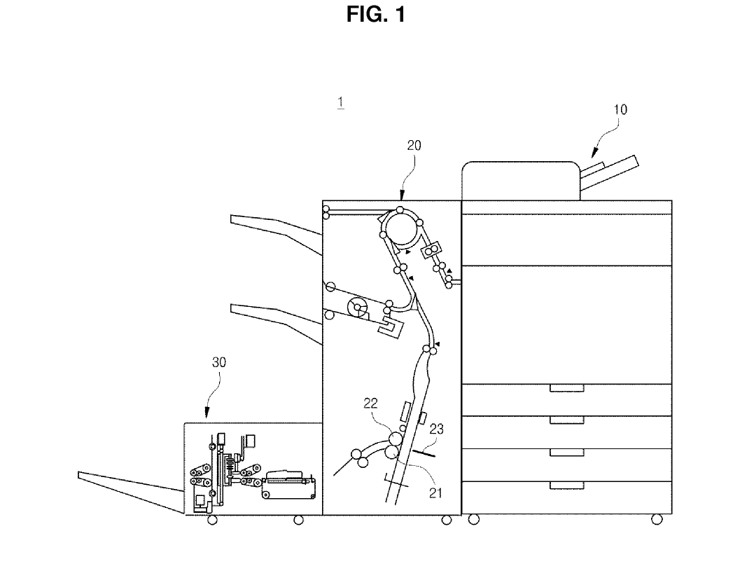

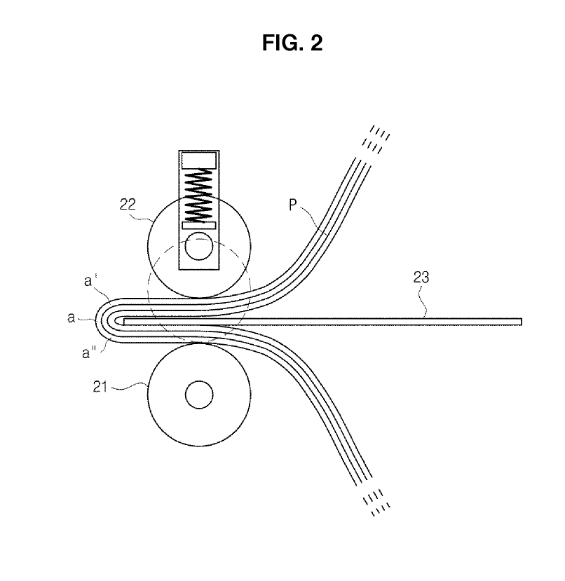

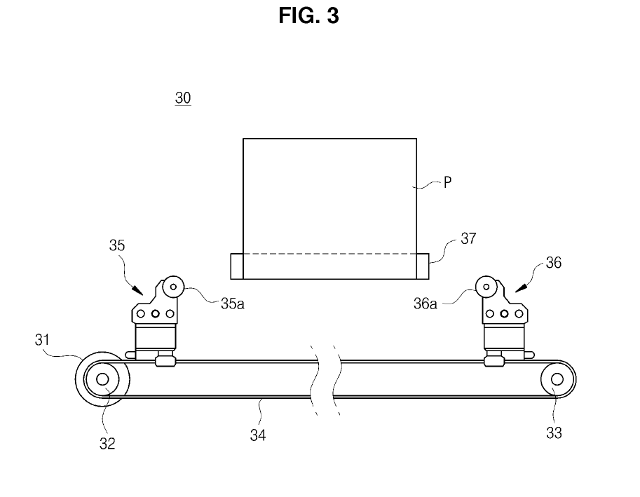

Referring to FIG. 1, an image forming apparatus 1 in accordance with an embodiment of the present application includes an image forming unit 10 forming an image on a printing medium, and a printing medium finishing unit 20 installed at one side of the image forming unit 10 in parallel to the image forming unit 10 and configured to receive printing media P (FIG. 2), which are completed with image formation, from the image forming unit 10 and allow middle portions of the received printing media P to be folded such that the printing media P are formed into a shape of a book.

The printing medium finishing unit 20 includes one pair of folding rollers 21 and 22 disposed apart from each other, and a folding knife 23 allowing the printing media to be folded while passing between the folding rollers 21 and 22.

One of the folding rollers 21 and 22 is a fixed roller 21 rotatably installed at a fixed position, and the remaining folding roller is a moving roller 22 installed so as to be movable toward the fixed roller 21. The moving roller 22 moves in response to the number of printing media P being folded.

The folding knife 23 is movably installed and has a front end entering a portion in between the folding rollers 21 and 22.

Accordingly, as the folding knife 23 presses middle portions of the printing media P while moving, the printing media P pass between the folding rollers 21 and 22 with the middle portions of the printing media P pressed by the folding knife 23 in a folded state, thereby folding the printing media P.

Rear ends “a” of the printing media P, that is, the folded portions of the printing media P obtained by passing through the folding rollers 21 and 22, have curved shapes a′, a″ at both sides of the folded portion “a” thereof, which causes a difference in shape from a real book whose pages have squared rear ends.

Accordingly, the printing medium finishing unit 20 is provided with a back processing unit 30 shown in FIG. 1 configured to deform rear ends of the folded printing media P into squared shapes.

The back processing unit 30 includes a first pressing module 35 configured to deform the rear ends of the folded printing media P into squared shapes, and a second pressing module 36 configured to deform edges of the folded printing media P that are formed by the first pressing module 35 into flat surfaces by pressing the edges of the folded printing media.

The first and second pressing modules 35 and 36 include first and second pressing rollers 35a and 36a, respectively, and are installed so as to be movable in a width direction of the folded printing media P. The first and second modules 35 and 36, while moving, allow the pressing rollers 35a and 36a to press the rear ends of the printing media P, thereby deforming the rear ends of the folded printing media P.

The first pressing roller 35a provided on the first pressing module 35 has a cylindrical shape and the second pressing roller 36a provided on the second pressing module 36 has a V-shaped groove formed on a circumferential surface thereof along a circumferential direction thereof.

In order to move the first and second pressing modules 35 and 36, the back processing unit 30 includes a driving motor 31 generating a rotary force, a driving pulley 32 rotated by the driving motor 31, a driven pulley 33 disposed while being spaced apart from the driving pulley 31 and a transfer belt 34 wound around the driving pulley 32 and the driven pulley 33. The first and second pressing modules 35 and 36 are installed on the transfer belt 34, and the pressing rollers 35a and 36a provided on either of the first and second pressing modules 35 and 36 press and deform the rear ends of the printing medium P while moving along the rear ends of the folded printing media P.

In addition, the back processing unit 30 include one pair of support plates 37 that are spaced apart from each other and support both sides of the folded printing media P, and a guide unit 38 configured to guide the folded printing media P to be introduced into between the support plates 37 and support the printing media P in a way that prevents the printing media P from being pushed backward during a process of pressing and deforming the rear ends of the printing media. The guide unit 38 in accordance with this embodiment of the present disclosure includes one pair of guide pulleys 38a and a guide belt 38b wound around the guide pulleys 38a.

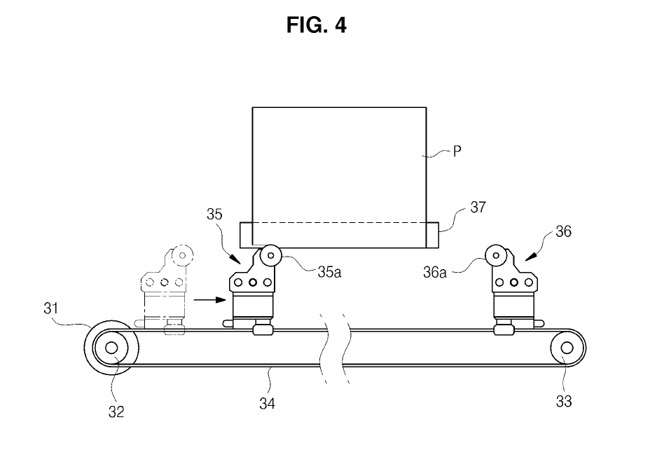

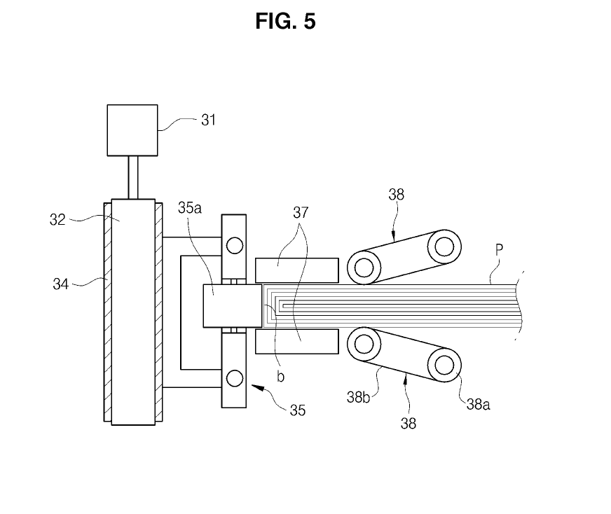

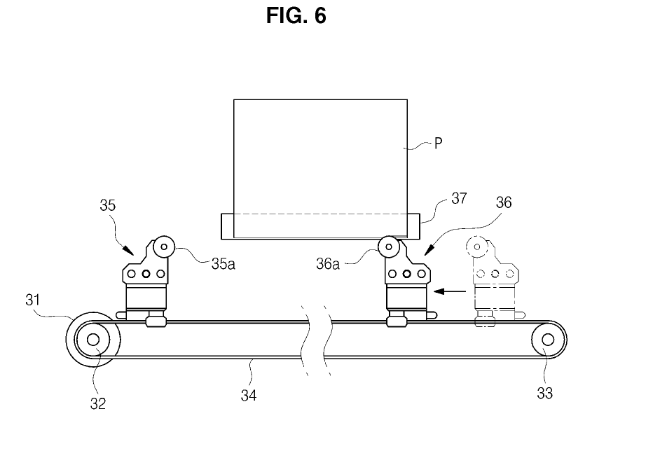

Accordingly, when the transfer belt 34 is moved in one direction by the driving motor 31, the first pressing module 35 installed on the transfer belt 34 is moved in the one direction by the transfer belt 34 as shown in FIG. 4. Accordingly, the first pressing roller 35a provided on the first pressing module 35 presses the rear ends of the folded printing media P such that the rear ends of the folded printing media P are formed into squared shapes “b” as shown in FIG. 5.

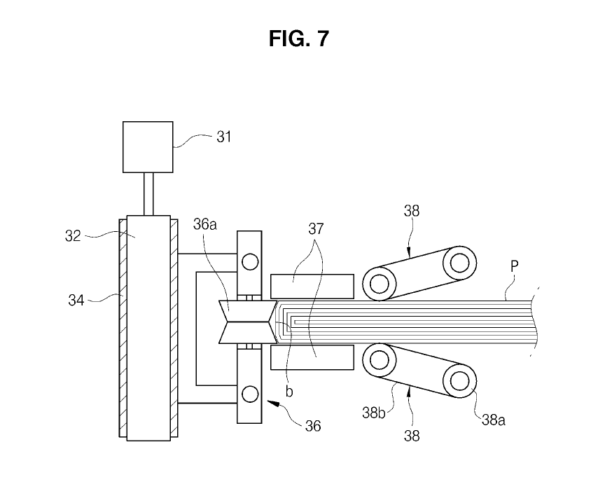

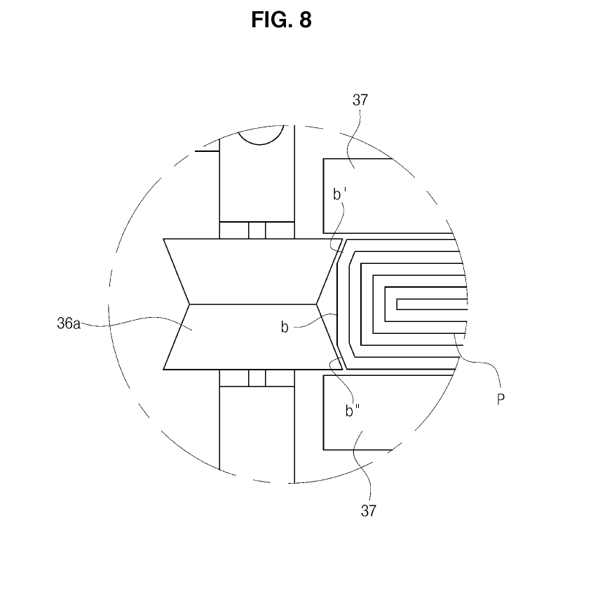

When the transfer belt 34 is moved in the other direction by the driving motor 31, the second pressing module 36 installed on the transfer belt 34 is moved in the other direction by the transfer belt 34 as shown in FIG. 7. Accordingly, the second pressing roller 36a provided on the second pressing module 36 presses edges of the rear ends of the folded printing media P, which had been deformed into squared shapes by the pressing roller 36a, into flat surfaces b′, b″, as shown in FIG. 8.

The flat surfaces deformed from the edges of the rear ends of the folded printing media P are stronger than the angled edges, and reduce the chance of being damaged, which facilitates storing the folded printing media P for a long period of time.

In addition, when the printing media P are deformed by the first pressing roller 35a, a portion adjacent to the edge of the rear end of the printing medium P may be wrinkled. However, such a wrinkle may be reduced by stretching by the second pressing roller 36a, so that the external appearance of the folded printing media P is improved.

Although the back processing unit 30 is shown in FIG. 1 to be disposed at one side of the printing medium finishing unit 20, the present disclosure is not limited thereto. For example, the back processing unit 30 may be contained in a casing of the printing medium finishing unit 20.

Although the first and second pressing rollers 35a and 36a are installed on the first and second pressing modules 35 and 36 installed on the transfer belt 34, and are configured to press the rear ends “a” of the folded printing media P while moving by the transfer belt 34, the present disclosure is not limited thereto. The first and second pressing rollers 35a and 36a may be moved through various other mechanisms, to press the rear ends of the folded printing media P.

Although the printing medium finishing unit 20 in accordance with this embodiment of the present disclosure includes the first pressing roller 35a provided in a cylindrical shape and the second pressing roller 36a provided with a V-shaped groove, the present disclosure is not limited thereto. For example, the printing medium finishing unit 20 may include a plurality of pressing modules each deforming the rear end of the printing media into a different shape, e.g. triangular, circular with different radii, having ribs, etc., so that the rear end of the folded printing media is deformed into a shape corresponding to a pressing roller included in a respective one of the plurality of pressing modules.

Although a few embodiments of the present disclosure have been shown and described, it would be appreciated by those skilled in the art that changes may be made in these embodiments without departing from the principles and spirit of the disclosure, the scope of which is defined in the claims and their equivalents.

1. A printing medium finishing unit comprising a back processing unit having a plurality of pressing modules each configured to deform rear ends of folded printing media into a different shape by pressing the rear ends of the folded printing media.

2. The printing medium finishing unit of claim 1, wherein the plurality of pressing modules include a first pressing module configured to deform the rear ends of the folded printing media into squared shapes by pressing the rear ends of the folded printing media, and a second pressing module configured to deform edges of the folded printing media P that are formed by the first pressing module into flat surfaces by pressing the edges of the folded printing media.

3. The printing medium finishing unit of claim 2, wherein:
the first pressing module moves in a width direction of the folded printing medium; and
the first pressing module includes a first pressing roller that is provided in a cylindrical shape to press the rear ends of the folded printing media.

4. The printing medium finishing unit of claim 3, wherein:
the second pressing module moves in a width direction of the folded printing medium; and
the second pressing module includes a second pressing roller that is provided at an outer circumferential surface thereof with a V-shaped groove formed along a circumferential direction thereof.

5. The printing medium finishing unit of claim 2, wherein:
the back processing unit includes a driving motor generating a rotary force, a driving pulley rotated by the driving motor, a driven pulley spaced apart from the driving pulley and a transfer belt wound around the driving pulley and the driven pulley; and the first pressing module and the second pressing module are installed on the transfer belt.

6. The printing medium finishing unit of claim 2, wherein the back processing unit includes one pair of support plates that are spaced apart from each other and support sides of the folded printing media.

7. The printing medium finishing unit of claim 1, further comprising:
folding rollers disposed apart from each other; and
a folding knife movably installed and having a front end entering between the folding rollers.

8. The printing medium finishing unit of claim 7, wherein one of the folding rollers is in a fixed position, and a second folding roller is movable toward the fixed roller.

9. An image forming apparatus comprising:
an image forming unit that forms an image on a printing medium; and
a printing medium finishing unit to fold printing media transmitted from the image forming unit,
wherein the printing medium finishing unit includes a plurality of pressing modules each configured to deform rear ends of folded printing media into a different shape by pressing the rear ends of the folded printing media.

10. The image forming apparatus of claim 9, wherein the plurality of pressing modules include a first pressing module configured to deform the rear ends of the folded printing media into squared shapes by pressing the rear ends of the folded printing media, and a second pressing module configured to deform edges of the folded printing media P that are formed by the first pressing module into flat surfaces by pressing the edges of the folded printing media.

11. The image forming apparatus of claim 10, wherein:
the first pressing module includes a first pressing roller that is provided in a cylindrical shape to press the rear end of the folded printing medium; and
the second pressing module includes a second pressing roller that is provided with a V-shaped groove formed along a circumferential surface thereof.

12. The image forming apparatus of claim 10, wherein:
the first pressing module and the second pressing module are movable in a width direction of the folded printing medium.

13. The image forming apparatus of claim 10, wherein the printing medium finishing unit includes a driving motor generating a rotary force, a driving pulley rotated by the driving motor, a driven pulley disposed while being spaced apart from the driving pulley and a transfer belt wound around the driving pulley and the driven pulley; and
the first pressing module and the second pressing module are installed on the transfer belt.

14. The image forming apparatus of claim 9, wherein the printing medium finishing unit includes one pair of support plates that are spaced apart from each other and support sides of the folded printing media.

15. The image forming apparatus of claim 9, further comprising:
folding rollers disposed apart from each other; and
a movable folding knife having a front end entering a portion between the folding rollers.

16. The image forming apparatus of claim 15, wherein one of the folding rollers is in a fixed position, and a second folding roller is movable toward the fixed roller.

17-20. (canceled)
